(19) United States
(12) Patent Application Publication
(10) Pub. No.: US 2011/0011122 A1
(43) Pub. Date: Jan. 20, 2011

(54) Portable bulkhead for refrigeration containers

(75) Inventor: Toby Clark, Phenix City, AL (US)

Correspondence Address: Steven W. Weinrieb;LAW OFFICES OF STEVEN W. WEINRIEB, 8717 Cold Spring Road, Potomac, MD, 20854, US

(73) Assignee: Illinois Tool Works Inc.

(21) Appl. No.: 12/801,184

(22) Filed: May 26, 2010

Related U.S. Application Data
(60) Provisional application No. 61/213,810, filed on Jul. 17, 2009.

(51) Int. Cl. F25D 3/00; B65D 25/04; B29C 41/20

(52) U.S. Cl. 62/457.1; 220/500; 264/129

(57) ABSTRACT

A new and improved portable bulkhead for use within, for example, refrigeration containers in order to, for example, divide the interior space of the refrigeration container into a predetermined refrigeration compartment within which a predetermined refrigeration temperature is to be maintained, wherein the new and improved portable bulkhead comprises a central core block fabricated from extruded polystyrene and having oppositely disposed side surface portions, and a pair of vinyl sheets respectively laminated onto the opposite side surface portions of the central core block so as to form, with the central core, a three-piece laminated portable bulkhead. The resulting bulkhead exhibits enhanced stiffness, rigidity, durability, service life expectancy, and does not readily absorb water which renders the same capable of being readily washed-down during cleaning and maintenance procedures.

### CROSS REFERENCE TO RELATED PATENT APPLICATIONS

This patent application is a non-provisional patent application based upon Provisional Patent Application Ser. No. 61/213,810 filed on Jul. 17, 2009, the priority benefits of which are hereby claimed.

### FIELD OF THE INVENTION

The present invention relates generally to portable bulkheads, partitions, space dividers, walls, and the like, and more particularly to a new and improved portable bulkhead for use within, for example, refrigeration containers in order to, for example, divide the interior space of the refrigeration container into a predetermined refrigeration compartment within which a predetermined refrigeration temperature is to be maintained, wherein the new and improved portable bulkhead comprises a central core block fabricated from extruded polystyrene and having oppositely disposed side surface portions, and a pair of vinyl sheets respectively laminated onto opposite side surface portions of the central core block so as to form, with the central core, a three-piece laminated portable bulkhead, such that the resulting bulkhead exhibits enhanced stiffness, rigidity, durability, service life expectancy, and does not readily absorb water which renders the same capable of being readily washed-down during cleaning and maintenance procedures.

### BACKGROUND OF THE INVENTION

Portable bulkheads, partitions, space dividers, walls, and the like, are currently in use within refrigeration containers so as to in fact divide the interior space of the refrigeration container into a predetermined refrigeration compartment within which a predetermined refrigeration temperature is to be maintained. Conventional bulkheads of the aforenoted type, however, have manufacturing and operational drawbacks which the refrigeration transportation industry would like to address. With reference being made to FIG. 1, a conventional PRIOR ART bulkhead is illustrated in cross-section and is generally indicated by the reference character 100. More particularly, it is seen that the conventional PRIOR ART bulkhead 100 comprises an inner or central core 102 which is fabricated from open cell foam material, more particularly, expanded polyethylene. The opposite side surfaces of the inner or central core 102 is then laminated with suitable thermoplastic sheets of corrugated polyurethane 104, and the opposite side surfaces of the laminated polyurethane 104 are, in turn, laminated with sheets of 18 ounce (18 oz.) vinyl 106. As is known in the industry, vinyl sheets are graded by weight, that is, 18 ounce vinyl means that the various sheets weigh 18 ounces per square yard.

As can be readily appreciated from the foregoing structure characteristic of the conventional PRIOR ART bulk-head 100, the bulkhead is relatively expensive to manufacture and is relatively heavy. More importantly, due to the composition of the same as comprising the inner or central core portion 102 being fabricated from the open cell foam material, that is, expanded polyethylene, the bulkhead does not exhibit a large or high degree of rigidity or stiffness which results in the bulkhead undergoing sagging or bowing over time. Still further, as a result of the disposition of the open cell foam material as the inner or central core structure 102 of the composite bulkhead 100, the lack of stiffness or rigidity permits the bulkhead 100 to be easily and readily deformed, bent, distorted, or the like, during its service, as a result of, for example, forklift trucks inadvertently contacting the same during, for example, the loading or unloading of refrigerated products into and out from the refrigeration containers. Accordingly, the bulkhead 100 does not exhibit a high or large degree of durability. Still yet further, again, as a result of the inner or central core portion 102 of the bulkhead 100 being fabricated from the aforenoted open cell foam material, the same tends to absorb water during, for example, washdown cleaning and maintenance procedures, by means of any opening leading to an external surface portion of the bulkhead 100, such as, for example, through means of handle structures incorporated upon the bulkhead, hinge mechanisms used upon the bulkhead when a plurality of the bulkheads are connected together so as to form a larger bulkhead extending across a substantial length or distance within the refrigeration container, and the like.

A need therefore exists in the industry for addressing the multitude of manufacturing and operational drawbacks characteristic of conventional PRIOR ART bulkheads as has been described hereinbefore.

### SUMMARY OF THE INVENTION

In accordance with the teachings and principles of the present invention, there is provided a new and improved bulk-head for refrigeration containers wherein the bulkhead comprises an inner or central core fabricated from a block of extruded foam insulation, particularly extruded polystyrene, one type of which is sold, for example, under the trademarked name STYROFOAM· by DOW CHEMICAL COMPANY, and wherein the opposite side surfaces of the inner or central core are laminated with 18 ounce (18 oz.) vinyl comprising polyvinylchloride (PVC). Accordingly, the resulting bulkhead comprises a three-piece laminated portable bulkhead member for use within a refrigeration container in order to define a refrigeration compartment. The vinyl sheets are an important part of the overall bulkhead in view of the fact that the same effectively protects the inner core from abrasion, and also permits other components to be welded or glued to the core, such as, for example, sealing gaskets and the like. As a result of the fabrication of the bulkhead from the extruded foam insulation, that is, the extruded polystyrene, material, the overall bulkhead exhibits enhanced rigidity, stiffness, and durability as compared to the afore-noted conventional PRIOR ART bulkhead. In addition, in view of the fact that the bulkhead only comprises the lamination of the 18 ounce vinyl upon the opposite side surfaces of the inner or central core member comprising the extruded polystyrene foam insulation, the manufacturing costs are significantly reduced. Still further, by eliminating the sheets of laminated polyurethane, the bulkhead of the present invention is significantly lighter in weight than the conventional PRIOR ART bulkhead. Finally, by fabricating the inner or central core portion of the bulkhead from a block of the extruded polystyrene foam insulation material, the bulkhead will not tend to absorb water during the wash-down cleaning and maintenance procedures.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic cross-sectional view of a conventional PRIOR ART bulkhead; and

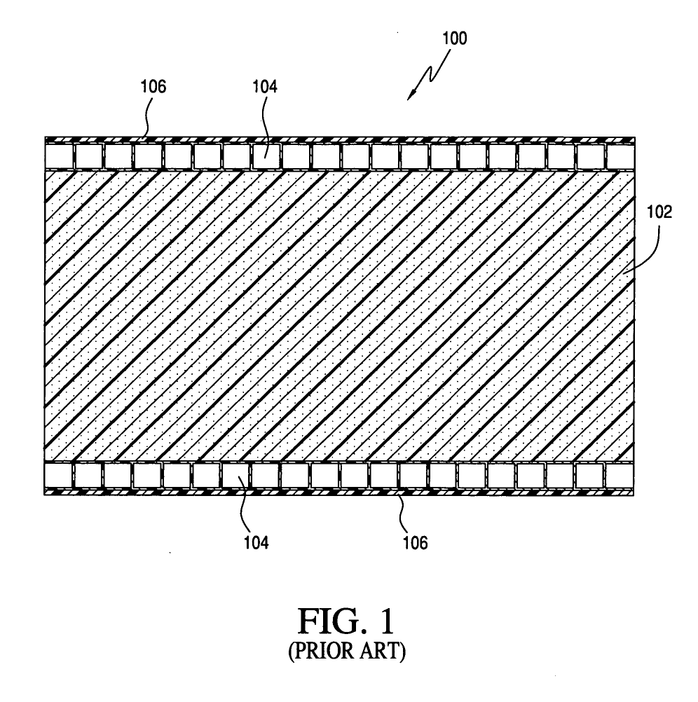

FIG. 2 is a schematic cross-sectional view, similar to that of FIG. 1, showing, however, the structure of the new and improved bulkhead constructed in accordance with the principles and teachings of the present invention.

### DETAILED DESCRIPTION OF THE PREFERRED EMBODIMENT

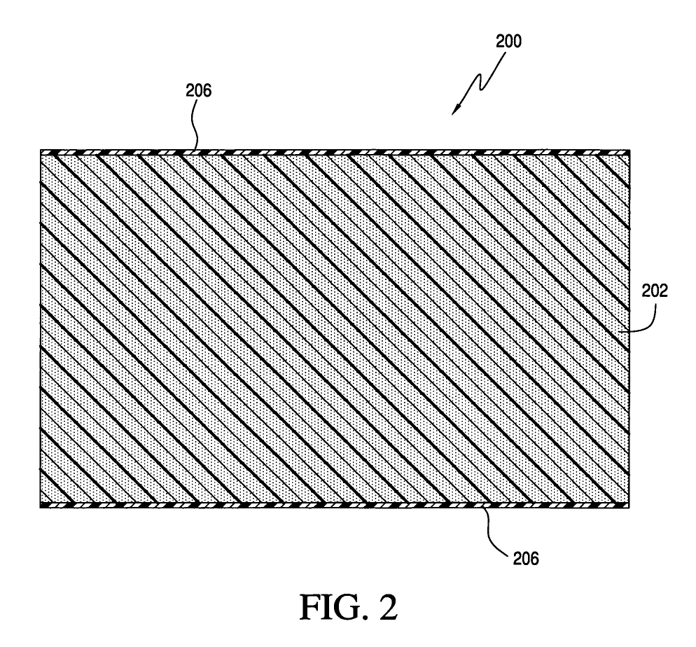

Referring now to the drawings, and more particularly to FIG. 2 thereof, a new and improved bulkhead, constructed in accordance with the principles and teachings of the present invention, is disclosed and is generally indicated by the reference character 200. Similarities between the new and improved bulkhead 200 of the present invention, and the conventional PRIOR ART bulkhead 100 will be readily apparent, and consequently, component parts of the new and improved bulkhead 200, which correspond to similar component parts of the conventional PRIOR ART bulkhead, will be designated by corresponding reference characters except that they will be within the 200 series. As can readily be appreciated, the new and improved bulkhead 200 constructed in accordance with the principles and teachings of the present invention is seen to comprise an inner or central core block 202 which is fabricated from a block of a suitable extruded foam insulation material, such as, for example, extruded polystyrene that is sold under the trademark STYROFOAM· by THE DOW CHEMICAL COMPANY. In addition, the opposite side surfaces of the bulkhead core portion 202 are laminated with sheets of 18 ounce (18 oz.) vinyl 206. The vinyl sheets are an important part of the overall bulkhead in view of the fact that the same effectively protects the inner core from abrasion, and also permits other components to be welded or glued to the core, such as, for example, sealing gaskets and the like. The sheets of 18 ounce vinyl 206 comprise a central or inner core scrim member, fabricated from a suitable polyester, and a substantially 60-40 blend of vinyl, comprising polyvinylchloride (PVC), coated onto the opposite side surfaces of the central or inner scrim member, that is, the vinyl is coated onto the central or inner core scrim member in liquid form, 60% upon one side of the central or inner core scrim member, and 40% upon the other side of the central or inner core scrim member. In this manner, the vinyl, when set, effectively becomes embedded within all of the interstices of the central or inner core scrim member so as to effectively impart to the vinyl sheets an integrally formed composite which cannot readily delaminate as is true of conventional laminated vinyl sheets.

As a result of the aforenoted structure comprising the new and improved bulkhead of the present invention, the manufacturing and operational advantages can be readily appreciated. More particularly, and probably most importantly, by effectively replacing the central or inner core component 102, comprising the open cell expanded polyethylene foam material, with the core blocks 202 of extruded polystyene foam insulation, which may comprise, for example, STYROFOAM· as manufactured by THE DOW CHEMICAL COMPANY, the resulting bulk-head 200 is provided with enhanced rigidity, strength, stiffness, and durability. Accordingly, the bulkhead will not tend to sag or bow over time, and will not be significantly damaged or otherwise rendered unfit for use, thereby significantly extending its service life. Still further, the core block extruded foam insulation material, comprising the central or inner core member 202 formed from the extruded polystyrene, unlike the open cell foam material, comprising expanded polyethylene, does not readily absorb water or moisture, and therefore the bulkheads 200 may be easily and readily washed-down during cleaning and maintenance procedures without the risk of deteriorating the structural integrity of the bulkhead 200 due to general deterioration, dissolution, or structural breakdown or degradation of the central or inner core member 202.

Still further, in view of the fact that the bulkhead 200 only comprises the lamination of the 18 ounce vinyl sheets 206 upon the opposite side surfaces of the inner or central core comprising the extruded polystyene foam insulation member 202, and not the lamination of the polyurethane sheets upon the opposite sides surfaces of the inner or central expanded polyethylene core block insulation member 102, the manufacturing costs are significantly reduced. Still yet further, by eliminating the sheets of laminated polyurethane, the bulkhead of the present invention is significantly lighter in weight than that of the conventional PRIOR ART bulkhead 100. It is lastly to be noted that the central or inner core blocks of extruded polystyrene foam insulation, as manufactured, for example, by THE DOW CHEMICAL COMPANY, under the trademark STYROFOAM·, may have dimensions approximating three inches (3.00″) thick, forty-six inches (46.00″) wide, and one hundred five (105.00″) high. The core blocks can of course be subsequently accordingly trimmed, connected together, and the like in order to fabricate bulkheads of predetermined dimensions in order to facilitate their service as bulkheads inside particular refrigeration containers.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of america, is:

1. A portable bulkhead for use within a refrigeration container, comprising:
a central core block fabricated from extruded polystyrene and having oppositely disposed side surface portions; and
a pair of vinyl sheets respectively laminated onto said opposite side surface portions of said central core block so as to form, with said central core, a three-piece laminated portable bulkhead.

2. The bulkhead as set forth in claim 1, wherein:
said central core block, fabricated from said extruded polystyrene, comprises STYROFOAM·.

3. The bulkhead as set forth in claim 1, wherein:
each one of said pair of vinyl sheets comprises a scrim, fabricated from polyester, and liquid polyvinylchloride (PVC) coated onto opposite side surface portions of said scrim.

4. The bulkhead as set forth in claim 3, wherein:
said vinyl sheets substantially comprise 60-40 vinyl sheet blends wherein 60% of said polyvinylchloride is coated onto one side surface portion of said scrim, while 40% of said polyvinyl-chloride is coated onto the other side surface portion of said scrim.

5. The bulkhead as set forth in claim 1, wherein:
each one of said vinyl sheets comprises 18 ounce (18 oz.) vinyl sheets.

6. The bulkhead as set forth in claim 1, wherein:
said central core block, comprising said extruded polystyrene, has external dimensions of approximately three inches (3″) thick, forty-six inch (46″) wide, and one hundred five inches (105″) high.

7. A method of fabricating a bulkhead member for use within a refrigeration container, comprising the steps of:
forming a central core block from extruded polystyrene such that said central core block has oppositely disposed side surface portions; and
respectively laminating a pair of vinyl sheets onto said opposite side surface portions of said central core block so as to form, with said central core, a three-piece laminated portable bulkhead.

8. The method as set forth in claim 7, further comprising the step of:
forming said central core block from STYROFOAM·.

9. The method as set forth in claim 7, further comprising the steps of:
forming each one of said pair of vinyl sheets from a scrim fabricated from polyester; and
coating liquid polyvinylchloride (PVC) onto opposite side surface portions of said scrim.

10. The method as set forth in claim 9, further comprising the step of:
forming each one of said vinyl sheets as substantially 60-40 vinyl sheet blends wherein 60% of said polyvinylchloride is coated onto one side surface portion of said scrim, while 40% of said polyvinyl-chloride is coated onto the other side surface portion of said scrim.

11. The method as set forth in claim 7, further comprising the step of:
forming each one of said vinyl sheets as 18 ounce (18 oz.) vinyl sheets.

12. The method as set forth in claim 7, further comprising the step of:
forming said central core block, comprising said extruded polystyrene, so as to have external dimensions of approximately three inches (3″) thick, forty-six inch (46″) wide, and one hundred five inches (105″) high.
